(19) United States
(12) Patent Application Publication
(10) Pub. No.: US 2013/0298794 A1
(43) Pub. Date: Nov. 14, 2013

(54) DIRECTLY IMAGEABLE WATERLESS LITHOGRAPHIC PRINTING PLATE PRECURSOR

(71) Applicants: Yuta Shuto, Otsu (JP); Akihiro Iihara, Otsu (JP); Kazuki Goto, Tokyo (JP); Satoshi Yoshida, Otsu (JP)

(72) Inventors: Yuta Shuto, Otsu (JP); Akihiro Iihara, Otsu (JP); Kazuki Goto, Tokyo (JP); Satoshi Yoshida, Otsu (JP)

(73) Assignee: Toray Industries, Inc., Tokyo (JP)

(21) Appl. No.: 13/979,733

(22) PCT Filed: Jan. 13, 2012
(86) PCT No.: PCT/JP2012/050562

§ 371 Date: Jul. 29, 2013

(30) Foreign Application Priority Data
Jan. 17, 2011 (JP) 2011-006570

(51) Int. Cl. B41N 1/14

(52) U.S. Cl. CPC B41N 1/14
USPC 101/465

(57) ABSTRACT

A directly imageable waterless lithographic printing plate precursor includes at least a heat sensitive layer and a silicone rubber layer formed on a substrate in this order, wherein the heat sensitive layer contains at least a novolac resin, a polyurethane and a light-to-heat conversion material, and also has a phase separation structure including at least a phase containing a novolac resin and a phase containing a polyurethane. The directly imageable waterless lithographic printing plate precursor has high sensitivity and is less likely to cause blister, that is, having wide latitude.

### TECHNICAL FIELD

This disclosure relates to a directly imageable waterless lithographic printing plate precursor and, particularly to a directly imageable waterless lithographic printing plate precursor which can directly perform plate processing using laser beam.

### BACKGROUND

There have been proposed various printing plates, using a silicone rubber or a fluorine resin as a material of an ink repellent layer, which are designed to perform lithographic printing without using a dampening solution (hereinafter referred to as waterless lithographic printing). Waterless lithographic printing is a lithographic printing method in which the image areas and the non-image areas are allowed to exist on almost the same plane, and the image areas and the non-image areas act as ink acceptable layer and ink repellent layer, respectively. The ink is adhered only to the image areas due to a difference in ink adhesion, and the ink adhered to the image area is transferred to a printing material such as paper. The feature of this method is to be able to perform printing without using a dampening solution.

There are various exposure methods proposed for waterless lithographic printing plate precursors. They are broadly divided into a method in which ultraviolet irradiation is performed through a plate making film, and a computer-to-plate (hereinafter referred to as “CTP”) method in which the original pattern is directly incised without using a plate making film. The CTP method includes a method of performing laser irradiation, a method in which the original pattern is incised by a thermal head, a method in which a voltage is partially applied using a pin electrode, and a method in which an ink acceptable layer or an ink repellent layer is formed using an ink-jet apparatus. Of these methods, the method of performing laser irradiation is superior to the other methods in view of resolution and plate processing speed.

The method of performing laser irradiation is divided into two types: a photon mode method by photoreaction and a heat mode method in which photothermal conversion is performed to cause thermal reaction. Particularly, the utility of the heat mode method is increasing because of its advantage for use in a bright room and the rapid progress of the semiconductor laser to be used as a light source.

Various proposals have been made on directly imageable waterless lithographic printing plate precursors which are designed for the heat mode method mentioned above. In particular, there has been proposed, as a directly imageable waterless lithographic printing plate precursor which can perform plate processing with less laser radiation energy and achieve satisfactory image reproducibility, a directly imageable waterless lithographic printing plate precursor which contains bubbles in a heat sensitive layer (see, for example, Japanese Unexamined Patent Publication (Kokai) No. 2005-300586). There has also been proposed, as a method of producing the directly imageable waterless lithographic printing plate precursor which can perform plate processing with less laser irradiation energy and achieve satisfactory image reproducibility, a method of producing a directly imageable waterless lithographic printing plate precursor, which comprises the steps of applying a solution of a heat sensitive layer composition containing an organic solvent having a solubility parameter of 17.0 (MPa)^{1/2} or less, and drying the heat sensitive layer composition (see, for example, Japanese Unexamined Patent Publication (Kokai) No. 2005-331924).

Directly imageable waterless lithographic printing plate precursors obtainable by technologies disclosed in Japanese Unexamined Patent Publication (Kokai) No. 2005-300586 and Japanese Unexamined Patent Publication (Kokai) No. 2005-331924 have high sensitivity and can be developed only by applying a physical force after exposure. However, the directly imageable waterless lithographic printing plate precursors having high sensitivity may sometimes cause a “blister” phenomenon in which a silicone rubber layer of the exposed area undergoes lifting in the step of producing the waterless lithographic printing plate, thus leading to transfer of the lifted silicone rubber layer to a conveyor roller in an exposure apparatus or an automatic development apparatus. The silicone rubber layer transferred to the conveyor roller may be sometimes retransferred to a surface of a plate to be subsequently treated, and thus causing exposure obstruction or development obstruction.

Therefore, it could be helpful to provide a directly imageable waterless lithographic printing plate precursor which has high sensitivity and is less likely to cause blister, that is, having wide latitude.

### SUMMARY

We provide a directly imageable waterless lithographic printing plate precursor comprising at least a heat sensitive layer and a silicone rubber layer formed on a substrate in this order, wherein the heat sensitive layer contains at least a novolac resin, a polyurethane and a light-to-heat conversion material, and also has a phase separation structure including at least a phase containing a novolac resin and a phase containing a polyurethane.

It is thus possible to obtain a directly imageable waterless lithographic printing plate precursor having wide latitude, which has high sensitivity and is excellent in blister resistance.

### BRIEF DESCRIPTION OF THE DRAWINGS

FIG. 1 is an electron micrograph of a cross section of a printing plate where there occurred a “blister” phenomenon in which a silicone rubber layer of the exposed area undergoes lifting.

FIG. 2 is a schematic view of a printing plate of the prior art, illustrating a state where there occurred a phenomenon in which a silicone rubber layer of the exposed area partially transfers to a conveyor roller.

FIG. 3 is a schematic view of an example of our printing plate illustrating a state where a phenomenon in which a silicone rubber layer of the exposed area partially transfers to a conveyor roller has been suppressed.

FIG. 4 is a schematic view of a “blister” phenomenon suppression mechanism due to a phase separation structure of a heat sensitive layer.

FIG. 5 is a photomicrograph of a surface of a heat sensitive layer obtained in Example 1.

FIG. 6 is a photomicrograph of a surface of a heat sensitive layer obtained in Example 9.

FIG. 7 is a photomicrograph of a surface of a heat sensitive layer obtained in Example 11.

FIG. 8 is a photomicrograph of a surface of a heat sensitive layer obtained in Comparative Example 6.

### REFERENCE SIGNS LIST

1: Heat sensitive layer in which blister has occurred after exposure
2: Silicone rubber layer
3: Primer layer
4: Printing plate
5: Conveyor roller
6: Silicone rubber layer transferred to conveyor roller
A: Exposed area
B: Unexposed area
7: Upper portion of heat sensitive layer after exposure
8: Layer containing relatively small amount of polyurethane
9: Layer containing relatively large amount of polyurethane

### DETAILED DESCRIPTION

Our directly imageable waterless lithographic printing plate precursor is a directly imageable waterless lithographic printing plate precursor comprising at least a heat sensitive layer and a silicone rubber layer formed on a substrate in this order, wherein the heat sensitive layer contains at least a novolac resin, a polyurethane and a light-to-heat conversion material, and also has a phase separation structure including at least a phase containing a novolac resin and a phase containing a polyurethane. The waterless lithographic printing plate precursor as used herein means a precursor of a printing plate capable of printing without using a dampening solution, and the directly imageable waterless lithographic printing plate precursor means a waterless lithographic printing plate precursor in which an original pattern is directly incised using laser beam.

The directly imageable waterless lithographic printing plate precursor is described below.

The directly imageable waterless lithographic printing plate precursor comprises at least a heat sensitive layer and a silicone rubber layer formed on a substrate in this order.

It is possible to use, as the substrate, dimensionally stable, publicly known materials such as paper, metal, glass and film which have hitherto been used as a substrate material of printing plates. Specific examples thereof include papers; papers laminated with plastic material (polyethylene, polypropylene, polystyrene, etc.); metal plates such as aluminum (including aluminum alloys), zinc, and copper; glass plates of soda lime glass and quart; silicon wafers; films of plastics such as cellulose acetate, polyethylene terephthalate, polyethylene, polyester, polyamide, polyimide, polystyrene, polypropylene, polycarbonate, and polyvinyl acetal; and papers or plastic films laminated or deposited with the metals. The plastic films may be transparent or opaque. From the viewpoint of proofing, an opaque film is preferable.

Of these substrates, an aluminum plate is particularly preferable because it is extremely stable dimensionally and low in price. As a flexible substrate for quick printing, a polyethylene terephthalate film is particularly preferable.

There is no particular limitation on the thickness of the substrate, and an appropriate thickness suitable for the printing machine to be used for lithographic printing may be selected.

The heat sensitive layer, which can be preferably used, is described below. The heat sensitive layer is a layer capable of being changed in physical properties by laser drawing and/or a layer capable of being lowered in the adhesive strength to the silicone rubber layer by laser drawing. The heat sensitive layer contains at least (A) a novolac resin, (B) a polyurethane, and (C) a light-to-heat conversion material, and also has a phase separation structure including at least a phase containing a novolac resin and a phase containing a polyurethane. The heat sensitive layer may further contain (D) an organic complex compound.

The phase containing a novolac resin may contain a polyurethane. The phase containing a polyurethane may contain a novolac resin. In this case, the heat sensitive layer has a phase separation structure including a phase containing relatively small amount of polyurethane and a phase containing relatively large amount of polyurethane. It has already experimentally confirmed that, in the heat sensitive layer, the moiety of the phase containing relatively large amount of polyurethane is locally desensitized, namely, the adhesive strength between the heat sensitive layer and the silicone rubber layer is increased.

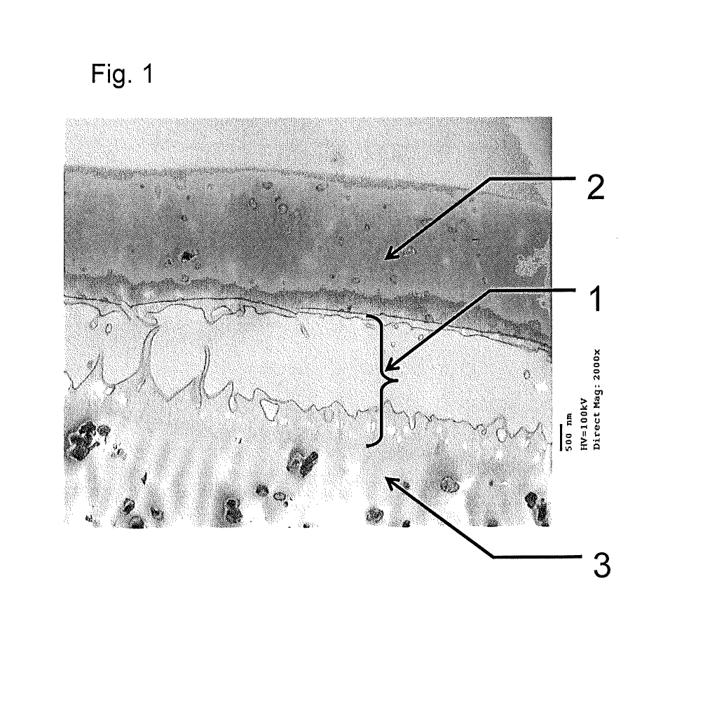

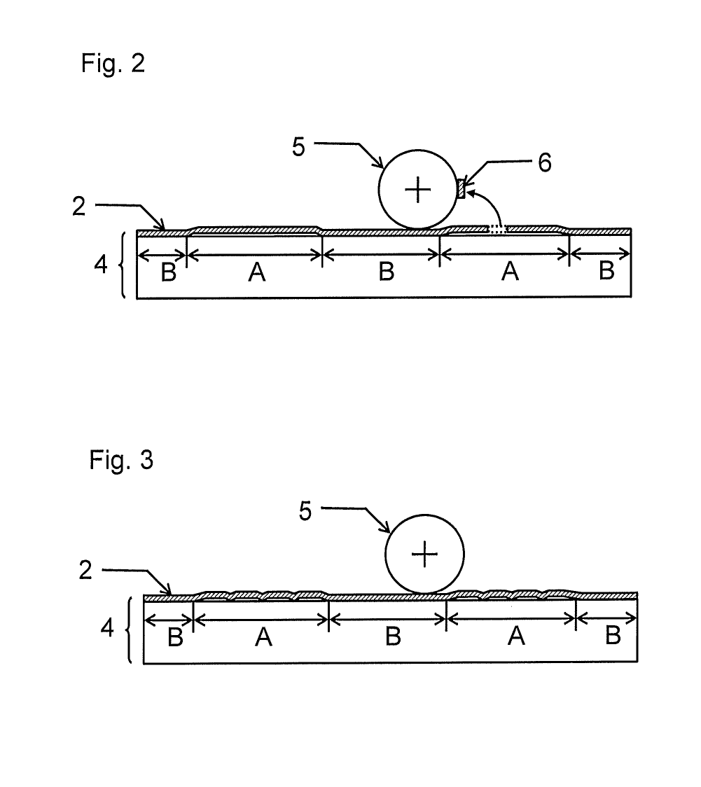

The directly imageable waterless lithographic printing plate precursors having high sensitivity as disclosed in Japanese Unexamined Patent Publication (Kokai) No. 2005-300586 and Japanese Unexamined Patent Publication (Kokai) No. 2005-331924 can be developed only by applying a physical force after exposure. Therefore, in the step of producing a waterless lithographic printing plate by exposing a waterless lithographic printing plate precursor, there sometimes occurs a phenomenon called “blister” in which a silicone rubber layer of the exposed area undergoes lifting. FIG. 1 is an electron micrograph of a cross section of a printing plate where there occurred a “blister” phenomenon in which a silicone rubber layer of the exposed area undergoes lifting. When the “blister” phenomenon occurs, the lifted silicone rubber layer may sometimes transfer to a conveyor roller in an exposure apparatus or an automatic development apparatus in the process of conveying the directly imageable waterless lithographic printing plate precursor after exposure, unfavorably. This state is shown in a schematic view of FIG. 2. The silicone rubber layer transferred to the conveyor roller may retransfer to a surface of a plate to be subsequently treated, and thus may cause exposure obstruction or development obstruction. The blister phenomenon becomes more likely to occur as the directly imageable waterless lithographic printing plate precursor has higher sensitivity. The blister phenomenon also becomes more likely to occur as the amount of light exposure increases.

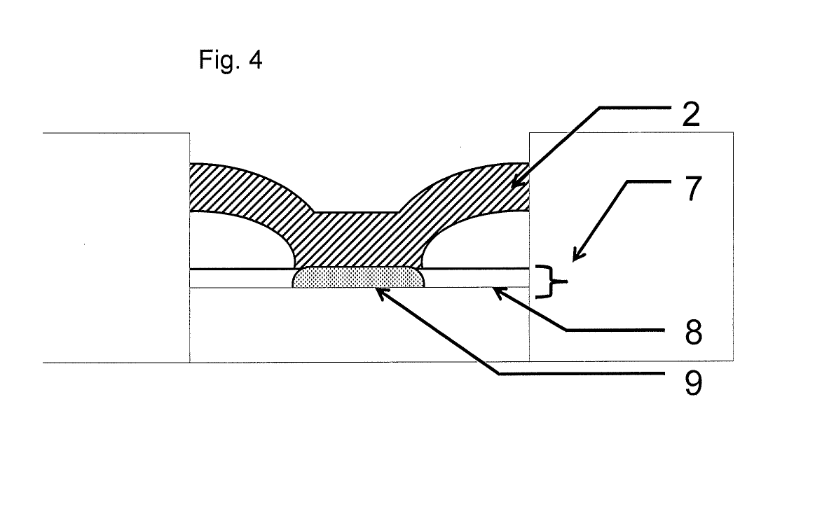

In the directly imageable waterless lithographic printing plate precursor, the heat sensitive layer has a phase separation structure includes at least a phase containing a novolac resin and a phase containing a polyurethane as mentioned above, whereby, the phase containing relatively large amount of polyurethane locally maintains the adhesive strength between the heat sensitive layer and the silicone rubber layer, and thus enabling suppression of the blister phenomenon. Namely, blister resistance is improved. FIG. 3 is a schematic view illustrating a state where a directly imageable waterless lithographic printing plate precursor is conveyed after exposure in the same manner as in the case of a waterless lithographic printing plate precursor of the prior art of FIG. 2. In the directly imageable waterless lithographic printing plate precursor, even if the lifted portion is formed in the silicone rubber layer, the portion with locally high adhesive strength maintains the adhesive strength between the heat sensitive layer and the silicone rubber layer, as illustrated in FIG. 4. Therefore, as illustrated in FIG. 3, the directly imageable waterless lithographic printing plate precursor can be conveyed without the silicone rubber layer transferring to a conveyor roller in an exposure apparatus or an automatic development apparatus. Thereby, exposure obstruction or development obstruction due to the “blister” phenomenon can be prevented.

The phase separation structure of the heat sensitive layer can be observed by observing the heat sensitive layer of the directly imageable waterless lithographic printing plate precursor at a magnification of 1,000 times using an optical microscope. For example, the phase separation structure can be observed by taking images of a sample cut into a square measuring 10 cm on each side at a resolution of 1,080×1,280 pixels (total magnification on monitor: 1,000 times, field of view: 180×240 μm) using a digital camera: “DXM” 1200F (manufactured by Nikon Corporation) connected to an optical microscope: “ECLIPSE” L200 (manufactured by Nikon Corporation), transmission mode, objective lens: “CFI LU Plan Apo EPI” 50X (manufactured by Nikon Corporation). In this case, it was judged that a phase separation structure is formed when individual phase separation structure has a linear size of 1 μm or more in any direction. When optical microscope observation is performed in a state where a heat sensitive layer is covered with a silicone rubber layer, it may sometimes be difficult to observe the phase separation structure because of excessive noise, and thus it is preferred to observe a sample with a heat sensitive layer being uncovered.

The size of individual phase of the phase separation structure can be controlled by selecting compatibility of polyurethane with other constituent components in the heat sensitive layer. It also can be controlled by selecting a method for formation of the heat sensitive layer. When using a method in which a heat sensitive layer composition solution containing heat sensitive layer components is applied on a substrate and then dried to form a heat sensitive layer, the size of individual phase separation structure can be controlled by selecting the concentration of the solution or drying rate.

It is possible to reconcile blister resistance and formation of high definition images by controlling the size of individual phase of the phase separation structure. In this case, an area percentage of the phase containing relatively large amount of polyurethane is preferably 50 area % or less in the total field of view of an optical microscope. From the viewpoint of further improvement in blister resistance, the area percentage of the phase containing relatively large amount of polyurethane is preferably 5 area % or more, and more preferably 10 area % or more.

It is also possible to observe the phase separation structure of the heat sensitive layer by a transmission electron microscope (TEM). More particularly, a sample is produced from a directly imageable waterless lithographic printing plate precursor by a serial (ultrathin) sectioning method, and the phase separation structure can be confirmed by performing TEM observation of the heat sensitive layer under the conditions of an acceleration voltage of 100 kV and a magnification of 15,000 times. It is the observation method which is useful for a sample in which a heat sensitive layer is covered with a silicone rubber layer.

The respective components composing the heat sensitive layer is described below.

### (A) Novolac Resin

Examples of the novolac resin used in the directly imageable waterless printing plate precursor include a novolac resin obtained by reacting phenols exemplified below with aldehydes exemplified below under an acidic catalyst.

Examples of the phenols include phenol; cresols such as m-cresol, p-cresol, and o-cresol; xylenols such as 2,3-xylenol, 2,5-xylenol, 3,5-xylenol, and 3,4-xylenol; alkylphenols; alkoxyphenols; isopropenylphenols; arylphenols; polyhydroxyphenols and the like. These phenols may be used alone, or two or more phenols may be used in combination. Of these phenols, phenol or o-cresol is preferable.

Examples of the aldehydes include formaldehyde, paraformaldehyde, trioxane, acetaldehyde, propionaldehyde and the like. These aldehydes may be used alone, or two or more aldehydes may be used in combination. Of these aldehydes, formaldehyde is preferable.

It is possible to use, as the acidic catalyst, hydrochloric acid, sulfuric acid, formic acid, oxalic acid, paratoluenesulfonic acid and the like.

Of these novolac resins, a phenol novolac resin or an o-cresol novolac resin is preferable.

A weight average molecular weight of the novolac resin is preferably 5,000 or less, and more preferably 4,000 or less. Use of the novolac resin having a weight average molecular weight of 5,000 or less enables easy crosslink cleavage upon laser irradiation, leading to further improvement in sensitivity. Meanwhile, a weight average molecular weight of the novolac resin is preferably 500 or more, and more preferably 800 or more. Use of the novolac resin having a weight average molecular weight of 500 or more enables improvement in adhesion of the heat sensitive layer to the silicone rubber layer. The weight average molecular weight of the novolac resin means a weight average molecular weight determined by gel permeation chromatography (GPC). Provided that a relative molecular weight distribution and a weight average molecular weight are determined by GPC, and the weight average molecular weight in the present invention is a molecular weight measured on the polystyrene equivalent basis.

The content of the novolac resin is preferably from 20 to 95% by weight in the total solid component of the heat sensitive layer from the viewpoint of coatability. The lower limit is more preferably 50% by weight or more, and the upper limit is more preferably 90% by weight or less.

### (B) Polyurethane

Examples of the polyurethane used in the directly imageable waterless printing plate precursor include a polyurethane obtained from polyisocyanates exemplified below and polyhydric alcohols exemplified below. The polyurethane may be linear or branched, or may have various functional groups such as a hydroxyl group. Two or more polyurethanes may be contained.

It is possible to use, as the polyisocyanate, an aromatic polydiisocyanate, an alicyclic polyisocyanate, or an aliphatic polyisocyanate. An aromatic polydiisocyanate is preferable.

Examples of the aromatic polyisocyanate include paraphenylene diisocyanate, 2,4- or 2,6-toluoylene diisocyanate (TDI), 4,4′-diphenylmethane diisocyanate (MDI), tolidine diisocyanate (TODI), xylylene diisocyanate (XDI) and the like. These aromatic polyisocyanates can be used alone, or a mixture of two or more aromatic polyisocyanates can be used.

Examples of the aliphatic or alicyclic polyisocyanate include hexamethylene diisocyanate, isophorone diisocyanate, norbornane diisocyanate, hydrogenated diphenylmethane diisocyanate, hydrogenated m-xylene diisocyanate and the like. These aliphatic or alicyclic polyisocyanates can be used alone, or a mixture of two or more aliphatic or alicyclic polyisocyanates can be used.

It is also possible to use modified compounds, derivatives and the like of the polyisocyanates. Examples of these modified compounds or derivatives include urethane-modified compounds which are reaction products of polyisocyanate and alcohol; dimers (another name: uretdione) or trimers (another name: isocyanurate) as reaction products of two or three polyisocyanates; polycarbodiimides produced by decarbonation; or allophanate-modified compounds, burette-modified compounds, urea-modified compounds and the like, which are reaction products of polyisocyanate, alcohol, amine compound and the like; and blocked isocyanates.

The polyisocyanate is preferably a polyisocyanate in which an aromatic polyisocyanate accounts for at least 50 mol % thereof, and more preferably a polyisocyanate in which an aromatic polyisocyanate accounts for 100% thereof. When the aromatic polyisocyanate accounts for 50 mol % or more of the polyisocyanate, the directly imageable waterless lithographic printing plate precursor has high sensitivity and is less likely to cause blister.

The polyhydric alcohol can be broadly divided into polyether polyol, polyester polyol, and others.

Specific examples of the polyether polyol include ethylene glycol, propylene glycol, 1,3-propanediol, 1,4-butanediol, 1,3-butylene glycol, 1,5-pentanediol, 1,6-hexanediol, diethylene glycol, dipropylene glycol, neopentyl glycol, triethylene glycol, p-xylylene glycol, hydrogenated bisphenol A, bisphenol dihydroxypropyl ether and the like.

The polyester polyol can be further divided into condensed polyester polyol, lactone-based polyester polyol, polycarbonate polyol and the like.

The condensed polyester polyol is obtained by dehydration condensation of a polyhydric carboxylic acid and an anhydride thereof with a glycol and/or a triol.

Examples of the polyhydric carboxylic acid and the polyhydric carboxylic anhydride include phthalic anhydride, isophthalic acid, terephthalic acid, succinic anhydride, adipic acid, azelaic acid, sebacic acid, tetrahydrophthalic anhydride, hexahydrophthalic anhydride, tetrabromophthalic anhydride, tetrachlorophthalic anhydride, HET anhydride, himic anhydride, maleic anhydride, fumaric acid, itaconic acid, trimellitic anhydride, methylcyclohexenetricarboxylic anhydride, pyromellitic anhydride and the like.

Specific examples of the condensed polyester polyol include polyethylene adipate, polypropylene adipate, polyhexamethylene adipate, polyneopentyl adipate, polyhexamethylene neopentyl adipate, polyethylene hexamethylene adipate, polytetramethylene adipate and the like.

Examples of the lactone-based polyester polyol include those obtained by ring-opening polymerization of lactones, such as β-propiolactone, γ-butyrolactone, δ-valerolactone, ε-caprolactone and the like.

Examples of the polycarbonate polyol include a ring-opening polymer of ethylene carbonate obtained by using, as an initiator, a low molecular weight polyol such as ethylene glycol, propylene glycol, 1,3-propanediol, 1,4-butanediol, 1,3-butylene glycol, 1,5-pentanediol, or 1,6-hexanediol; and an amorphous polycarbonate polyol obtained by copolymerizing a dihyric alcohol such as 1,4-butanediol, 1,5-pentanediol, 3-methyl-1,5-pentanediol, or 1,6-hexanediol with a ring-opening polymer of ethylene carbonate.

Examples of the other polyhydric alcohol include an acrylic polyol which is a copolymer of an acrylic (or methacrylic) monomer having a hydroxyl group, such as β-hydroxyethyl methacrylate, with an acrylic (or methacrylic) acid ester; a polybutadiene polyol which is butanediene having a hydroxyl group at the end and a copolymer thereof; a partially saponified EVA and the like. The other polyhydric alcohol further includes various phosphorus-containing polyol, halogen-containing polyol, phenol-based polyol and the like.

The polyhydric alcohol is preferably polyester polyol. Of these polyester polyols, condensed polyester polyol and lactone-based polyester polyol are preferable.

A phase separation structure of a heat sensitive layer can be formed by making use of a difference in solubility between the novolac resin and the polyurethane. It has become experimentally clear that use of a polyurethane having a softening point of 200° C. or higher enables easy formation of a phase separation structure including a phase containing a novolac resin as a major component and a phase containing a polyurethane as a major component.

As used herein, a softening point of the polyurethane can be measured based on JIS-K 7210 (1999) using a Kouka-shiki flow tester (constant-load orifice-type flow tester) CFT-500D (manufactured by Shimadzu Corporation). While heating 1 g of a sample resin at a temperature rise rate of 6° C./min, a load of 1.96 MPa was applied by a plunger and the resin was extruded through a nozzle having a diameter of 1 mm and a length of 1 mm. The amount of descent of the plunger of the flow tester with respect to temperature was plotted (plunger descent amount-temperature curve). The temperature corresponding to ½ (the temperature at which one-half of the measurement sample flowed out) of a maximum value of the amount of descent of the plunger is defined as the softening point of the sample.

The total content of the novolac resin and the polyurethane in the total solid component of the heat sensitive layer is preferably 25% by weight or more, more preferably 55% by weight or more, and still more preferably 70% by weight or more. When the total content of the novolac resin and the polyurethane is 25% by weight, it is easy to form a phase separation structure.

The content of the polyurethane in the total solid component of the heat sensitive layer is preferably 5% by weight or more from the viewpoint of formation of the phase separation structure. Meanwhile, the content of the polyurethane in the total solid component of the heat sensitive layer is preferably 30% by weight or less, and more preferably 20% by weight or less, from the viewpoint of maintaining sensitivity higher.

The content of the polyurethane is preferably 8% by weight or more, and more preferably 10% by weight or more, based on the total amount of the novolac resin and the polyurethane so as to suppress blister. The content of the polyurethane is preferably 25% by weight or less based on the total amount of the novolac resin and the polyurethane so as to impart high sensitivity to a directly imageable waterless lithographic printing plate precursor.

### (C) Light-to-Heat Conversion Material

There is no particular limitation on a light-to-heat conversion material as long as it absorbs laser beam, and a pigment or dye capable of absorbing infrared rays or near infrared rays is preferable. Examples thereof include black pigments such as carbon black, carbon graphite, aniline black, and cyanine black; green pigments such as phthalocyanine-based and naphthalocyanine-based pigments; crystallization water-containing inorganic compounds; metal powders such as powders of iron, copper, chromium, bismuth, magnesium, aluminum, titanium, zirconium, cobalt, vanadium, manganese, and tungsten; or sulfides, hydroxides, silicates, sulfates, phosphates, diamine compound complexes, dithiol compound complexes, phenolthiol compound complexes, and mercaptophenol compound complexes of these metals.

It is possible to preferably use, as the dye which absorbs infrared rays or near infrared rays, dyes for electronic devices or recorders with a maximum absorption wavelength within a range from 700 nm to 1,500 nm, such as cyanine-based dyes, azulenium-based dyes, squarylium-based dyes, croconium-based dyes, azo-based disperse dyes, bisazostilbene-based dyes, naphthoquinone-based dyes, anthraquinone-based dyes, perylene-based dyes, phthalocyanine-based dyes, naphthalocyanine metal complex-based dyes, polymethine-based dyes, dithiol-nickel complex-based dyes, indoaniline metal complex dyes, intramolecular type CT dyes, benzothiopyran-based spiropyran, and nigrosine dyes.

Of these dyes, those having a large molar absorption coefficient ε are preferably used. Specifically, c is preferably 1×10⁴ or more, and more preferably 1×10⁵ or more. When ε is 1×10⁴ or more, it is possible to further improve initial sensitivity.

The heat sensitive layer may contain two or more light-to-heat conversion materials. Inclusion of two or more light-to-heat conversion materials each having a different absorption wavelength makes it possible to use two or more types of laser beams each having a different transmission wavelength.

Of these light-to-heat conversion materials, carbon black and dyes capable of absorbing infrared rays or near infrared rays are preferable from the viewpoint of the light-heat conversion efficiency, economic efficiency, and handleability.

The content of the light-to-heat conversion material in the total solid component of the heat sensitive layer is preferably from 0.1 to 70% by weight from the viewpoint of capability of being imaged. The lower limit of the content is more preferably 0.5% by weight or more, and the upper limit is more preferably 40% by weight or less.

### (D) Organic Complex Compound

The organic complex compound is composed of a metal and an organic compound, and functions as a curing agent of a polymer having active hydrogen, such as a novolac resin, and/or as a catalyst of thermosetting reaction.

Examples of the organic complex compound include organic complex salts consisting of an organic ligand coordinated to a metal, organic-inorganic complex salts consisting of an organic ligand and an inorganic ligand coordinated to a metal, and metal alkoxides consisting of a metal and organic molecules covalently bonded via oxygen. Of these organic complex compounds, metal chelate compounds with a ligand containing two or more donor atoms to form a ring containing a metallic atom are preferable in view of stability of the organic complex compound itself and stability of the solution of the heat sensitive layer composition.

As the metals composing an organic complex compound, Al(III), Ti(IV), Mn(II), Mn(III), Fe(II), Fe(III), CO(II), Co(III), Ni(II), Ni(IV), Cu (I), Cu(II), Zn(II), Ge, In, Sn(II), Sn(IV), Zr(IV), and Hf(IV) are preferable. Al(III) is particularly preferable because it can improve the sensitivity effectively, and Ti(IV) is particularly preferable because it serves effectively to increase resistance to printing inks and ink-washing liquids.

The ligand includes a compound having a coordinating group containing oxygen, nitrogen, sulfur, etc. as a donor atom. Specific examples of the coordinating group include those with oxygen as a donor atom such as —OH (alcohol, enol, and phenol), —COOH (carboxylic acid), >C═O (aldehyde, ketone, quinone), —O— (ether), —COOR (ester with R representing an aliphatic or aromatic hydrocarbon), —N═O (nitroso compound), —NO₂ (nitro compound), >N—O (N-oxide), —SO₃H (sulfonic acid), —PO₃H₂ (phosphorous acid) and the like. Specific examples of the coordinating group include those with nitrogen as a donor atom such as —NH₂ (primary amine, amide, hydrazine), >NH (secondary amine, hydrazine), >N-(tertiary amine), —N═N-(azo compound, heterocyclic compound), ═N—OH (oxime), —NO₂ (nitro compound), —N═O (nitroso compound), >C═N— (Schiff base, heterocyclic compound), >C═NH (aldehyde, ketone imine, enamines), —NCS (isothiocyanate) and the like. Specific examples of the coordinating group include those with sulfur as a donor atom such as —SH (thiol), —S-(thioether), >C═S (thioketone, thioamide), ═S-(heterocyclic compound), —C(═O)—SH, —C(═S)—OH, —C(═S)—SH (thiocarboxylic acid), —SCN (thiocyanate) and the like.

Of these organic complex compounds consisting of the metal and ligand mentioned above, compounds used preferably include complex compounds of metals such as Al(III), Ti(IV), Fe(II), Fe(III), Mn(III), Co(II), Co(III), Ni(II), Ni(IV), Cu (I), Cu(II), Zn(II), Ge, In, Sn(II), Sn(IV), Zr(IV), and Hf(IV) with β-diketones, amines, alcohols, or carboxylic acids. Particularly preferable complex compounds include acetyl acetone complexes or acetoacetic acid ester complexes of Al(III), Fe(II), Fe(III), Ti(IV) or Zr(IV).

Specific examples of these compounds include the following compounds such as aluminum tris(acetylacetonate), aluminum tris(ethylacetoacetate), aluminum tris(propylacetoacetate), aluminum tris(butylacetoacetate), aluminum tris(hexylacetoacetate), aluminum tris(nonylacetoacetate), aluminum tris(hexafluoropentadionate), aluminum tris(2,2,6,6-tetramethyl-3,5-heptanedionate), aluminum bis(ethylacetoacetate) mono(acetylacetonate), aluminum bis(acetylacetonate) mono(ethylacetoacetate), aluminum bis(propylacetoacetate) mono(acetylacetonate), aluminum bis(butylacetoacetate) mono(acetylacetonate), aluminum bis(hexylacetoacetate) mono(acetylacetonate), aluminum bis(propylacetoacetate) mono(ethylacetoacetate), aluminum bis(butylacetoacetate) mono(ethylacetoacetate), aluminum bis(hexylacetoacetate) mono(ethylacetoacetate), aluminum bis(nonylacetoacetate) mono(ethylacetoacetate), aluminum dibutoxide mono(acetylacetonate), aluminum diisopropoxide mono(acetylacetonate), aluminum diisopropoxide mono(ethylacetoacetate), aluminum-s-butoxide bis(ethylacetoacetate), aluminum di-s-butoxide mono(ethylacetoacetate), and aluminum diisopropoxide mono(-9-octadecenylacetoacetate); titanium triisopropoxide mono(allylacetoacetate), titanium diisopropoxide bis(triethanolamine), titanium di-n-butoxide bis(triethanolamine), titanium diisopropoxide bis(acetylacetonate), titanium di-n-butoxide bis(acetylacetonate), titanium diisopropoxide bis(2,2,6,6-tetramethyl-3,5-heptanedionate), titanium diisopropoxide bis(ethylacetoacetate), titanium di-n-butoxide bis(ethylacetoacetate), titanium tri-n-butoxide mono(ethylacetoacetate), titanium triisopropoxide mono(methacryloxyethylacetoacetate), titanium oxide bis(acetylacetonate), titanium tetra(2-ethyl-3-hydroxyhexyloxide), titanium dihydroxybis(lactate), and titanium(ethylene glycolate) bis(dioctylphosphate); zirconium di-n-butoxide bis(acetylacetonate), zirconium tetrakis(hexafluoropentanedionate), zirconium tetrakis(trifluoropentanedionate), zirconium tri-n-propoxide mono(methacryloxyethylacetoacetate), zirconium tetrakis(acetylacetonate), zirconium tetrakis(2,2,6,6-tetramethyl-3,5-heptanedionate), triglycolate zirconic acid, and trilactate zirconic acid; and iron(III) acetylacetonate, dibenzoyl methane iron(II), tropolone iron, tris-tropolone iron(III), hinokithiol iron, tris-hinokitiol iron(III), acetoacetate iron(III), iron(III) benzoyl acetonate, iron(III) diphenylpropanedionate, iron(III) tetramethylheptanedionate, and iron(III) trifluoropentanedionate. The heat sensitive layer may contain two or more of these compounds.

The content of the organic complex compound in the total solid component in the heat sensitive layer is preferably from 0.5 to 50% by weight, and more preferably from 3 to 30% by weight. It is possible to further improve the above-mentioned effect by controlling the content of the organic complex compound to 0.5% by weight or more. It is possible to maintain high printing durability of the printing plate by controlling the content to 50% by weight or less.

In the directly imageable waterless lithographic printing plate precursor, the heat sensitive layer may contain, in addition to the novolac resin, an active hydrogen group-containing compound. Examples of the active hydrogen group-containing compound include a hydroxyl group-containing compound, an amino group-containing compound, a carboxyl group-containing compound, a thiol group-containing compound and the like, and the hydroxyl group-containing compound is preferable.

The hydroxyl group-containing compound can be divided into a phenolic hydroxyl group-containing compound and an alcoholic hydroxyl group-containing compound.

Examples of the phenolic hydroxyl group-containing compound include hydroquinone, catechol, guaiacol, cresol, xylenol, naphthol, dihydroxyanthraquinone, dihydroxybenzophenone, trihydroxybenzophenone, tetrahydroxybenzophenone, bisphenol A, bisphenol S, a resol resin, a resorcin-benzaldehyde resin, a pyrogallol acetone resin, polymer and copolymer of hydroxystyrene, a rosin-modified phenol resin, an epoxy-modified phenol resin, a lignin-modified phenol resin, an aniline-modified phenol resin, a melamine-modified phenol resin, bisphenols and the like.

Examples of the alcoholic hydroxyl group-containing compound include ethylene glycol, diethylene glycol, triethylene glycol, tetraethylene glycol, polyethylene glycol, propylene glycol, dipropylene glycol, polypropylene glycol, 1,3-butanediol, 1,4-butanediol, 1,6-hexanediol, 1,8-octanediol, 1,9-nonanediol, 1,10-decanediol, 2-butene-1,4-diol, 5-hexene-1,2-diol, 7-octene-1,2-diol, 3-mercapto-1,2-propanediol, glycerol, diglycerol, trimethylolpropane, 1,2,4-butanetriol, pentaerythritol, dipentaerythritol, sorbitol, sorbitan, polyvinyl alcohol, cellulose and derivatives thereof, polymer and copolymer of hydroxyethyl (meth)acrylate and the like.

Epoxy acrylate, epoxy methacrylate, a polyvinyl butyral resin, and a polymer having a hydroxyl group introduced by a known method may be contained.

In the directly imageable waterless lithographic printing plate precursor, the heat sensitive layer may optionally contain various additives. The heat sensitive layer may contain a silicone-based surfactant or a fluorine-based surfactant so as to improve coatability. The heat sensitive layer may also contain a silane coupling agent or a titanium coupling agent to enhance adhesion to the silicone rubber layer. The content of these additives vary depending on the intended purposes. Generally, the content of additives in the heat sensitive layer is preferably from 0.1 to 30% by weight.

For the purpose of achieving high sensitivity, the directly imageable waterless lithographic printing plate precursor may have bubbles in the heat sensitive layer. Examples of the method in which bubbles are formed in the heat sensitive layer include a method disclosed in Japanese Unexamined Patent Publication (Kokai) No. 2005-300586 or Japanese Unexamined Patent Publication (Kokai) No. 2005-331924.

For the purpose of maintaining high sensitivity after the lapse of time, in addition to the achievement of higher sensitivity immediately after the production of the precursor, the directly imageable waterless lithographic printing plate precursor may contain liquid bubbles in the heat sensitive layer. It is preferred that the heat sensitive layer contain liquid bubbles containing a liquid having a boiling point within a range from 210 to 270° C., whereby it is possible to obtain directly imageable waterless lithographic printing plate precursor which can maintain high sensitivity over a long period of time. That is, inclusion of a liquid having a boiling point of 210° C. or higher enables easy maintaining of the form of the liquid bubbles over a long period of time, and thus making it possible to maintain high sensitivity over a long period of time. On the other hand, inclusion of a liquid having a boiling point of 270° C. or lower enables higher initial sensitivity, and also enables suppression of bleed out of the liquid to a surface of the heat sensitive layer and peeling of the silicone rubber layer at the time of development.

As used herein, a boiling point of the liquid means a boiling point under an atmospheric pressure. When the liquid bubble contains two or more liquids, that is, in the case of having a plurality of boiling points, the proportion of the liquid having a boiling point within a range from 210 to 270° C. is preferably 60% by weight or more, more preferably 80% by weight or more, still more preferably 90% by weight or more, and yet more preferably 100% by weight.

The liquid contained in the liquid bubbles can be identified by collecting a gas obtained from temperature programmed desorption mass spectrometry and analyzing the composition of the gas.

The solubility parameter of the liquid contained in the liquid bubbles is preferably 17.0 (MPa)^{1/2} or less, and more preferably 16.5 (MPa)^{1/2} or less. Since a liquid with a solubility parameter of 17.0 (MPa)^{1/2} or less has low compatibility with the polymers mentioned below, the solubility of the polymers in such a liquid and/or the solubility of the liquid in the polymers is low, and thus easily allowing bubbles of the liquid to exist in the heat sensitive layer.

The solubility parameter means the Hildebrand solubility parameter, which is the amount δ defined as δ=(ΔH/V)^{1/2} where ΔH denotes molar heat of vaporization of the liquid, and V denotes its molar volume. The unit (MPa)^{1/2} is used to represent the solubility parameter. Liquids with a solubility parameter of 17.0 (MPa)^{1/2} or less include, but not limited to, an aliphatic hydrocarbon, an alicyclic hydrocarbon, and an alkylene oxide dialkyl ether. An aliphatic saturated hydrocarbon is preferable from the viewpoint of economic efficiency and safety.

The solubility parameter of a liquid contained in liquid bubbles can also be confirmed from literature based on their structure identified from the composition of gas obtained in temperature programmed desorption mass spectrometry.

Examples of the liquid having a boiling point within a range from 210 to 270° C. and a solubility parameter of 17.0 (MPa)^{1/2} or less include linear, branched, or cyclic hydrocarbons having 12 to 18 carbon atoms, alkylene glycol dialkyl ethers such as diethylene glycol butyl methyl ether (boiling point: 212° C., solubility parameter: 16.0 (MPa)^{1/2}), diethylene glycol dibutyl ether (boiling point: 256° C., solubility parameter: 15.8 (MPa)^{1/2}), triethylene glycol dimethyl ether (boiling point: 216° C., solubility parameter: 16.2 (MPa)^{1/2}), triethylene glycol butyl methyl ether (boiling point: 261° C., solubility parameter: 16.2 (MPa)^{1/2}), and tripropylene glycol dimethyl ether (boiling point: 215° C., solubility parameter: 15.1 (MPa)^{1/2}). Two or more thereof may be contained.

The liquid bubble contained in then heat sensitive layer can be observed by TEM. More particularly, a sample is produced from a directly imageable waterless lithographic printing plate precursor by a serial (ultrathin) sectioning method, and liquid bubbles can be observed by TEM observation of the heat sensitive layer under the conditions of an acceleration voltage of 100 kV and a magnification of 15,000 times.

The directly imageable waterless lithographic printing plate precursor containing these bubbles or liquid bubbles in the heat sensitive layer is likely to cause blister because of high sensitivity. Our approach exerts particularly high effect on these precursors having high sensitivity.

The thickness of the heat sensitive layer is preferably from 0.1 to 10 g/m² from the viewpoint of printing durability and productivity. The lower limit of the thickness is more preferably 0.5 g/m² or less, and the upper limit is more preferably 7 g/m² or less.

A primer layer may be provided between the above-mentioned substrate and heat sensitive layer for the purpose of improving adhesion between the substrate and the heat sensitive layer, preventing light halation, improving proofing properties, improving insulation, improving printing durability, etc. The primer layer includes, for example, a primer layer disclosed in Japanese Unexamined Patent Publication (Kokai) No. 2004-199016.

It is possible to use, as the silicone rubber layer used, any type of silicone rubber layers including an addition reaction type silicone rubber layer, a condensation reaction type silicone rubber layer, and a combination type silicone rubber layer of an addition reaction type silicone rubber layer and a condensation reaction type silicone rubber layer, which have hitherto been proposed as a waterless lithographic printing plate precursor. Examples thereof include silicone rubber layers disclosed in Japanese Unexamined Patent Publication (Kokai) No. 2007-78918, Japanese Unexamined Patent Publication (Kokai) No. 2005-309302, Japanese Unexamined Patent Publication (Kokai) No. 2009-80422 and the like.

The thickness of the silicone rubber layer is preferably from 0.1 to 10 g/m² from the viewpoint of ink repellency and resistance to scratches. The lower limit is more preferably 0.5 g/m² or more, and the upper limit is more preferably 7 g/m² or less.

The directly imageable waterless lithographic printing plate precursor may include a protective film and/or an interleaving paper on the silicone rubber layer for the purpose of protecting the silicone rubber layer.

The protective film is preferably a film having a thickness of 100 μm or less which allows laser beam to satisfactorily pass through. Typical examples thereof include polyethylene, polypropylene, polyvinyl chloride, polyethylene terephthalate, cellophane and the like. Various light absorbents, photofading materials, or photochromic materials as disclosed in Japanese Unexamined Patent Publication (Kokai) No. 2-063050 may be provided on the protective film so as to prevent the precursor from reacting when exposed to ambient light.

The interleaving paper preferably has a weight of 30 g/m² or more from a viewpoint of mechanical strength. On the other hand, the interleaving paper preferably has a weight of 120 g/m² or less since not only an economic advantage is obtained, but also the laminate consisting of the waterless lithographic printing plate precursor and the paper can be decreased in thickness, leading to higher handleability. The interleaving paper having a weight of 90 g/m² or less is more preferable. Preferable examples of the interleaving paper include, but not limited to, information recording base paper 40 g/m² (manufactured by Nagoya Pulp Co., Ltd.), metal interleaving paper 30 g/m² (manufactured by Nagoya Pulp Co., Ltd.), unbleached kraft paper 50 g/m² (manufacture by Chuetsu Pulp & Paper Co., Ltd.), NIP paper 52 g/m² (manufactured by Chuetsu Pulp & Paper Co., Ltd.), pure white roll paper 45 g/m² (manufactured by Oji paper Co., Ltd.), and Clupak 73 g/m² (manufactured by Oji paper Co., Ltd.).

Examples of the method of producing the directly imageable waterless lithographic printing plate precursor are shown below. A heat sensitive layer composition solution containing the above-mentioned heat sensitive layer components are applied to a substrate to form a heat sensitive layer. A phase separation structure can be formed in the heat sensitive layer due to a difference in solubility between the above-mentioned novolac resin and polyurethane.

When a solvent with a solubility parameter of 17.0 (MPa)^{1/2} or more and a solvent with a solubility parameter of 17.0 (MPa)^{1/2} or less are contained as the solvent of the heat sensitive layer components, bubbles or liquid bubbles can be formed in the heat sensitive layer. The solvent with a solubility parameter of more than 17.0 (MPa)^{1/2} serves to dissolve or disperse the heat sensitive layer components, while the solvent with a solubility parameter of 17.0 (MPa)^{1/2} or less serves to form bubbles or liquid bubbles in the heat sensitive layer.

The solvent with a solubility parameter of more than 17.0 (MPa)^{1/2} preferably has the ability to dissolve or disperse the heat sensitive layer components. Examples thereof include alcohols, ethers, ketones, esters, and amides. Two or more of them may be contained.

In the solvent with a solubility parameter of more than 17.0 (MPa)^{1/2}, it is preferable that those solvent components with a boiling point of 30 to 200° C. account for 80% weight or more, more preferably 95% weight or more. If those solvent components with a boiling point of 200° C. or lower account for 80% weight or more, the solvent can be easily removed from the heat sensitive layer by the below-mentioned drying. It is particularly preferable that those solvent components with a boiling point of 80° C. or lower account for 80% weight or more, and more preferably 90% weight or more. If solvent components with a boiling point of 30° C. or higher account for 80% by weight or more, preparation of a coating solution can be performed easily and stably at ambient temperature without using any special cooling device.

Before application of the heat sensitive layer composition solution, the coating surface of the substrate is preferably degreased. A primer layer composition solution containing the above-mentioned primer layer constituent components is optionally applied to form a primer layer, and then a heat sensitive layer may be formed on the primer layer. Next, a silicone rubber layer composition solution containing the above-mentioned silicone rubber layer components is applied on the heat sensitive layer to form a silicone rubber layer, and thus a directly imageable waterless lithographic printing plate can be obtained. Each composition solution may optionally contain, in addition to the above-mentioned components, other components such as solvents.

Examples of the coating apparatus of each solution include a slit die coater, a direct gravure coater, an offset gravure coater, a reverse roll coater, a natural roll coater, an air knife coater, a roll blade coater, a Vari-Bar roll blade coater, a two stream coater, a rod coater, a wire bar coater, a dip coater, a curtain coater, and a spin coater.

A heat treatment may be performed so as to dry or cure each layer. Examples of the heat treatment apparatus include common heating apparatuses such as a hot air dryer or an infrared dryer.

For protection of the plate surface during storage, it is preferable to provide a protective film and/or an interleaving paper on the resulting directly imageable waterless lithographic printing plate precursor.

Next, a method of producing a waterless lithographic printing plate from the directly imageable waterless lithographic printing plate precursor is described. The waterless lithographic printing plate as referred to herein is a printing plate having a patterned silicone rubber layer on the surface to work as an ink repelling layer. The printing plate is used in a printing process in which the patterned silicone rubber layer is used as non-image area and the silicone-rubber-free part as image area, and the difference in adherence to ink between the non-image area and the image area is made use of so that the ink is attached only to the image area and transferred to the printing material such as paper. The method of producing the waterless lithographic printing plate comprises the step of exposing the directly imageable waterless lithographic printing plate precursor to laser beam according to the image pattern (exposure step) and the step of applying friction to the exposed directly imageable waterless lithographic printing plate precursor in the presence of water or a liquid consisting of water and a surface active agent to remove the silicone rubber layer from the exposed area (development step).

First, the exposure step is described. The directly imageable waterless lithographic printing plate precursor is exposed to laser beam that scans it according to an image pattern of digital data. In the case where the directly imageable waterless lithographic printing plate precursor has a protective film, it is preferred to remove the protective film before exposure. The light source used for the exposure step has, for example, an emission wavelength in the range of 700 nm to 1,500 nm. In particular, a semiconductor laser or a YAG laser with an emission wavelength near the near-infrared region is preferably used. Specifically, a laser with a wavelength of 780 nm, 830 nm, or 1,064 nm is preferably used for the plate processing step from the viewpoint of handleability in a bright room.

The developing step is described below. Friction is applied to the exposed precursor in the presence of water or a liquid consisting of water and a surface active agent (hereinafter referred to a developer) to remove the silicone rubber layer from the exposed area. The friction step may be carried out by (i) the method of wiping the plate surface with unwoven cloth, absorbent cotton, cloth, or sponge dampened with a developer, (ii) the method of scrubbing the plate surface with a rotary brush in a shower of tap water etc. after pre-treatment of the plate surface with a developer, or (iii) the method of applying a pressured jet of water, warm water, or steam to the plate surface.

Before development, pre-treatment of soaking the plate in a pre-treatment liquid for a certain period may be conducted. The pre-treatment liquid may be water; a liquid obtained by adding a polar solvent such as alcohol, ketone, ester, and carboxylic acid to water; a liquid obtained by adding a polar solvent to at least one solvent such as aliphatic hydrocarbon and aromatic hydrocarbon; or a polar solvent. A known surface active agent may be added appropriately to the developer composition. It is preferable to use a surface active agent that forms a solution of pH 5 to 8 when added to water from the viewpoint of safety, cost for disposal, etc. The content of the surface active agent in the developer is preferably 10% by weight or less. The developer mentioned above has a high level of safety and also economic efficiency in terms of disposal cost. Further, it is preferred to use a glycol compound or glycol ether compound as a major component and it is more preferred that an amine compound is made to exist together.

It is possible to use, as the pre-treatment liquid and the developer, pre-treatment liquids and developer disclosed in Japanese Unexamined Patent Publication (Kokai) No. 63-179361, Japanese Unexamined Patent Publication (Kokai) No. 4-163557, Japanese Unexamined Patent Publication (Kokai) No. 4-343360, Japanese Unexamined Patent Publication (Kokai) No. 9-34132, and Japanese Patent Registration No. 3716429. Specific examples of the pre-treatment liquid include PP-1, PP-3, PP-F, PP-FII, PTS-1, PH-7N, CP-1, NP-1, and DP-1 (all of which are manufactured by Toray Industries Inc.).

Dyes such as crystal violet, victoria pure blue, and astrazon red may be added to the developer so that the ink acceptable layer of the image area is colored at the time of development so as to improve visibility of the image area and accuracy of half tone dot measurement. It is also possible to use the developers containing the dyes to perform dying after the development step.

Some or entire part of the development step may be performed automatically by an automatic development apparatus. The automatic development apparatus may be a device only with a development unit, a device with a pre-treatment unit and a development unit installed in this order, a device with a pre-treatment unit, a development unit, and an post-treatment unit installed in this order, or a device with a pre-treatment unit, a development unit, a post-treatment unit, and a water washing unit installed in this order. Specific examples of the automatic development apparatus include TWL-650 series, TWL-860 series, TWL-1160 series (all of which are manufactured by Toray Industries Inc.), and the automatic development apparatuses disclosed in Japanese Unexamined Patent Publication (Kokai) No. 4-2265, Japanese Unexamined Patent Publication (Kokai) No. 5-2272, and Japanese Unexamined Patent Publication (Kokai) No. 5-6000, which may be used alone or in combination.

When piling up printing plates for storage after the development step, it is preferable to use interleaving paper between the plates to protect the plate surfaces.

### EXAMPLES

Our precursors and methods are described in more detail below. The evaluations in the respective Examples and Comparative Examples were performed by the following procedures.

### <Measurement of Weight Average Molecular Weight of Novolac Resin>

A weight average molecular weight of a novolac resin was determined under the following conditions using GPC. The novolac resin was added to tetrahydrofuran so as to adjust the concentration to 0.2 w/v %, followed by gentle stirring at room temperature. It was confirmed by visual observation that the novolac resin was satisfactorily dissolved, and the obtained solution was filtered through a membrane filter (pore diameter: 0.45 μm, manufactured by TOSOH CORPORATION) to obtain a sample.

Apparatus: Gel permeation chromatography GPC (manufactured by TOSOH CORPORATION)
Detector: Differential refractive index detector RI (Model 8020, sensitivity: 32, manufactured by TOSOH CORPORATION)
Columns: TSKgel G4000HXL, G3000HXL, G2000HXL (manufactured by TOSOH CORPORATION)

### Solvent: Tetrahydrofuran

Flow rate: 1.0 mL/min
Injection amount: 0.200 mL
Standard sample: Monodispersed polystyrene (manufactured by TOSOH CORPORATION)

### <Measurement of Softening Point of Polyurethane>

A softening point of the polyurethane was measured based on JIS-K 7210 (1999) using a Kouka-shiki flow tester (constant-load orifice-type flow tester) CFT-500D (manufactured by Shimadzu Corporation). While heating 1 g of a measurement sample at a temperature rise rate of 6° C./min, a load of 1.96 MPa was applied by a plunger and the sample was extruded through a nozzle having a diameter of 1 mm and a length of 1 mm. The amount of descent of the plunger of the flow tester with respect to temperature was plotted (plunger descent amount-temperature curve). The temperature corresponding to ½ (the temperature at which one-half of the measurement sample flowed out) of a maximum value of the amount of descent of the plunger was defined as the softening point.

### <Observation of Phase Separation Structure>

After cutting a sample before lamination of a silicone rubber layer, in which a primer layer and a heat sensitive layer are provided on an aluminum substrate, into a square measuring 10 cm on each side. Using a digital camera: “DXM” 1200F (manufactured by Nikon Corporation) connected to an optical microscope: “ECLIPSE” L200 (manufactured by Nikon Corporation), transmission mode, digital camera: “CFI LU Plan Apo EPI” 50X (manufactured by Nikon Corporation), images of a surface of a heat sensitive layer were taken (total magnification on a monitor: 1,000 times) and then evaluated. In case where individual phase separation structure has a linear size of 1 μm or more to any direction, it was judged that a phase separation structure is formed. In case where individual phase separation structure has a size of less than 1 μm, or phase separation could not be recognized, it was judged that a phase separation structure is not formed.

### <Evaluation of Blister Resistance>

The obtained directly imageable waterless lithographic printing plate precursor was mounted to a platesetter “PlateRite” 8800E (manufactured by DAINIPPON SCREEN MFG. CO., LTD.) and then the whole surface of the precursor was subjected to solid image exposure at irradiation energy of 80 mJ/cm². A surface of the wholly exposed plate discharged from the platesetter was visually observed, and it was evaluated whether or not lifting of the silicone rubber layer occurred. In case where lifting of a silicone rubber layer was not recognized, irradiation energy was increased by 5 mJ/cm² and the same evaluation was conducted until lifting of the silicone rubber layer was recognized or irradiation energy reached 175 mJ/cm². A maximum light exposure value at which lifting of the silicone rubber layer was not recognized (blister-resistant maximum light exposure value) was determined.

### <Evaluation of Solid Image Reproducibility>

Using an automatic development apparatus “TWL-860KII” (manufactured by Toray Industries Inc.), the wholly exposed plate obtained by the above evaluation of blister resistance was developed under the conditions of pre-treatment liquid: none, developer: tap water (room temperature), post-treatment liquid: tap water (room temperature), and a plate passing rate: 80 cm/min. A series of operations were performed to obtain a directly imageable waterless lithographic printing plate in which the silicone rubber layer of the laser irradiated area was peeled. The obtained printing plate was visually observed to determine a minimum light exposure value at which the silicone rubber layer of the solid image exposed area could be peeled (solid reproduction minimum light exposure value).

### <Latitude>

Latitude was calculated by the following equation from blister resistant maximum light exposure value and solid reproduction minimum light exposure value, which were obtained by the above-mentioned method.

Latitude (mJ/cm²)=blister-resistant maximum light exposure value(mJ/cm²)−solid reproduction minimum light exposure value(mJ/cm²)

### <TEM Observation of Directly Imageable Waterless Lithographic Printing Plate Precursor>

A sample was produced from a directly imageable waterless lithographic printing plate precursor before laser irradiation by an ultrathin sectioning method. Using a transmission electron microscope, Model H-1700FA (Hitachi, Ltd.), a heat sensitive layer and a silicone rubber layer of the directly imageable waterless lithographic printing plate precursor were observed at an acceleration voltage of 100 kV and a magnification of 2,000 times (8,000 times only in the case of liquid bubble observation).

### Synthesis Example 1

### Synthesis of Polyurethane A

In a four-necked flask, 200 parts by weight of polybutylene adipate diol (having a number average molecular weight of 2,000) and 75 parts by weight of 4,4′-diphenylmethane diisocyanate were charged and reacted under a dry nitrogen atmosphere at 100° C. for 2 hours, and 670 parts by weight of DMF was further charged to obtain homogeneous system. After controlling the temperature in the system to 50° C., 14.4 parts by weight of ethylene glycol was charged and a chain elongation reaction was performed at 70° C. for 4 hours to obtain a polyurethane A having a resin concentration of 30% and a viscosity of 40,000 mPa·s (20° C.).

### Example 1

The following primer layer composition solution was applied on a 0.24 mm thick degreased aluminum substrate (manufactured by Mitsubishi Aluminum Co., Ltd.) and then dried at 200° C. for 90 seconds to provide a primer layer having a thickness of 10 g/m². The primer layer composition solution was obtained by mixing the following components with stirring at room temperature.

### <Primer Layer Composition Solution>

(a) Epoxy resin: “Epikote” (registered trademark) 1010 (manufactured by Japan Epoxy Resins Co. Ltd.): 35 parts by weight

(b) Polyurethane: “Sanprene” (registered trademark) LQ-T1331D (manufactured by Sanyo Chemical Industries Ltd., solid component concentration: 20% by weight): 375 parts by weight

(c) Aluminum chelate: “Aluminum Chelate” ALCH-TR (manufactured by Kawaken Fine Chemicals Co., Ltd.): 10 parts by weight

(d) Leveling agent: “Disparlon” (registered trademark) LC951 (Manufactured by Kusumoto Chemicals Ltd., solid component: 10% by weight): 1 part by weight

(e) Titanium oxide: N,N-dimethylformamide dispersion (titanium oxide: 50% by weight) of “Tipaque” (registered trademark) CR-50 (manufactured by Ishihara Sangyo Keisha, Ltd.): 60 parts by weight

(f) N,N-dimethylformamide: 730 parts by weight

(g) Methyl ethyl ketone: 250 parts by weight

Next, the following heat sensitive layer composition solution was applied on the primer layer and then heated at 120° C. for 30 seconds to provide a heat sensitive layer having a thickness of 1.4 g/m². The heat sensitive layer composition solution was obtained by mixing the following components with stirring at room temperature.

### <Heat Sensitive Layer Composition Solution>

(a) Phenol-formaldehyde novolac resin: “Sumilite Resin” (registered trademark) PR50716 (manufactured by Sumitomo Bakelite Co., Ltd., weight average molecular weight: about 3,500): 99 parts by weight

(b) Polyurethane solution: “Sanprene” (registered trademark) LQ-X5 (manufactured by Sanyo Chemical Industries Ltd., polyurethane obtained from polyisocyanate in which aromatic polyisocyanate accounts for 50 mol % or more thereof, and polyester polyol, softening point: 185° C., solid component concentration: 30% by weight): 56 parts by weight

(c) Infrared ray absorption dye: “PROJET” 825LDI (manufactured by Avecia Limited): 15 parts by weight

(d) Titanium di-n-butoxybis(acetyl acetonate) solution: “Nācem” (registered trademark) titanium (manufactured by Nihon Kagaku Sangyo Co., Ltd., solid component concentration: 73% by weight): 12 parts by weight

(e) Tetrahydrofuran (boiling point: 66° C.): 620 parts by weight

(f) Methyl ethyl ketone (boiling point: 79° C.): 51 part by weight

(g) Ethanol (boiling point: 78° C.): 129 parts by weight

(h) Isoparaffin: “Isopar” (registered trademark) M (manufactured by Esso Chemical Co., Ltd., boiling point: 223 to 254° C., solubility parameter: 14.7 (MPa)^{1/2}): 17 parts by weight

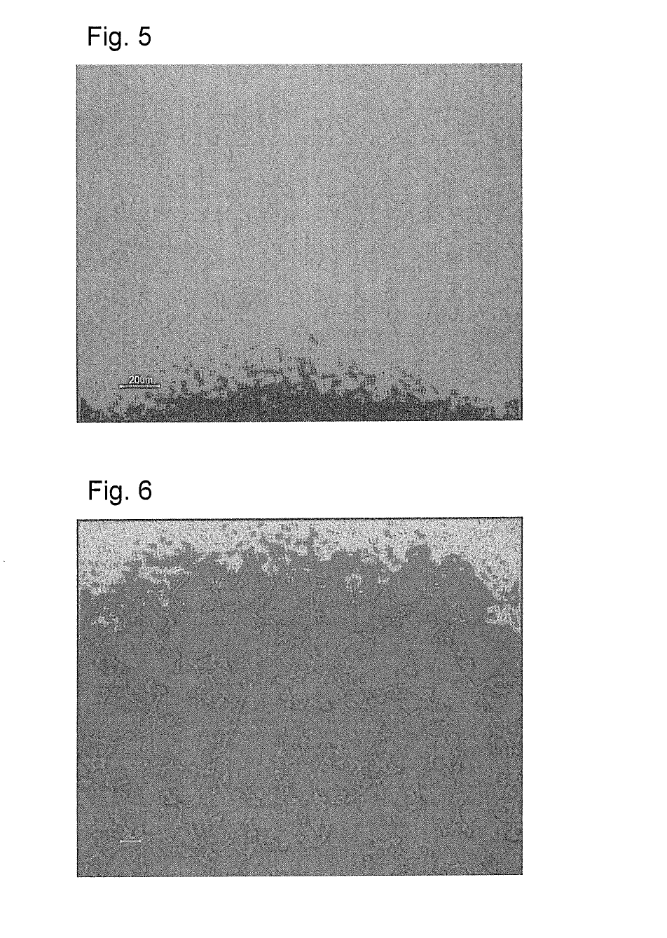

Using a sample provided with the above heat sensitive layer, it was observed whether or not a phase separation structure exists by the above method. A photomicrograph of a surface of the obtained heat sensitive layer is shown in FIG. 5. The scale in the drawing shows a length of 20 μm. The drawing shows a phase separation structure in which a phase containing relatively large amount of polyurethane is distributed in the form of a network in a matrix phase containing relatively small amount of polyurethane.

Next, the following colored pigment-containing silicone rubber layer composition solution was applied on the heat sensitive layer and then heated at 135° C. for 80 seconds to provide a silicone rubber layer having a thickness of 1.8 g/m², and thus a directly imageable waterless lithographic printing plate precursor was obtained.

### <Silicone Rubber Layer Composition Solution>

In a sealable glass standard bottle filled with 2,000 g of zirconia beads: “YTZ” (registered trademark) ball (φ 0.6 mm, manufactured by manufactured by Nikkato Corp.), 420 g of “Isopar” (registered trademark) G (manufactured by Esso Chemical Co., Ltd.), 40 g of “Plenact” (registered trademark) KR-TTS (manufactured by Ajinomoto Fine Techno Co., Ltd.), and 100 g of Milori Blue N650 (manufactured by Dainichiseika Color & Chemicals Mfg. Co., Ltd.) were charged. After sealing, the sealable glass standard bottle was set to a portable ball mill rotating stand (manufactured by AS ONE Corporation), followed by dispersion at a rotating speed of 0.4 m/second for 336 hours to obtain a colored pigment dispersion. The following components were mixed with 3 parts by weight of the obtained colored pigment dispersion under stirring at room temperature to obtain a silicone rubber layer composition solution.

(a) Isoparaffin: “Isopar” (registered trademark) E (manufactured by Esso Chemical Co., Ltd.): 550 parts by weight
(b) Both vinyl-terminated polydimethylsiloxane “DMS” V52 (manufactured by Gelest Inc.): 81.28 parts by weight
(c) SiH group-containing polysiloxane: “HMS” 991 (manufactured by Gelest Inc.): 3 parts by weight
(d) Vinyltris(methyl ethyl ketooxyimino)silane: 3 parts by weight
(e) 3-Glycidoxypropyltrimethoxysilane: “Sila-Ace” (registered trademark) 5510 (manufactured by CHISSO CORPORATION): 4 parts by weight
(f) Platinum catalyst: “SRX”212 (manufactured by Dow Corning Toray Co., Ltd.): 7 parts by weight

With regard to the thus obtained directly imageable waterless CTP lithographic printing plate precursors, observation of a phase separation structure as well as evaluation of blister resistance and solid reproducibility were performed by the above procedures. The results are shown in Table 1.

With regard to the directly imageable waterless lithographic printing plates, TEM observation was performed by the above procedure. As a result, liquid bubbles were observed in the heat sensitive layer. Liquid bubbles had an average diameter of 0.15 μm. Analysis results of liquid bubbles revealed that an “Isopar” M-derived liquid having a boiling point within a range from 223 to 254° C. exists.

### Example 2

In the same manner as in Example 1, except that polyurethane in the heat sensitive layer was replaced by polyurethane A (polyurethane obtained from aromatic polyisocyanate and polyester polyol, softening point: 185° C., solid component concentration: 30% by weight) produced in Synthesis Example 1, a directly imageable waterless lithographic printing plate precursor was produced and evaluated. The results are shown in Table 1.

### Example 3

In the same manner as in Example 1, except that the amount of tetrahydrofuran in the heat sensitive layer composition solution was changed to 398 parts by weight, a directly imageable waterless lithographic printing plate precursor was produced and evaluated. The results are shown in Table 1.

### Example 4

In the same manner as in Example 1, except that the amount of tetrahydrofuran in the heat sensitive layer composition solution was changed to 1,020 parts by weight, a directly imageable waterless lithographic printing plate precursor was produced and evaluated. The results are shown in Table 1.

### Example 5

In the same manner as in Example 1, except that the amount of the novolac resin in the heat sensitive layer composition solution was changed to 94 parts by weight, the amount of polyurethane was changed to 75 parts by weight, and the amount of tetrahydrofuran was changed to 607 parts by weight, a directly imageable waterless lithographic printing plate precursor was produced and evaluated. The results are shown in Table 1.

### Example 6

In the same manner as in Example 1, except that the amount of the novolac resin in the heat sensitive layer composition solution was changed to 97 parts by weight, the amount of polyurethane was changed to 65 parts by weight, and the amount of tetrahydrofuran was changed to 614 parts by weight, a directly imageable waterless lithographic printing plate precursor was produced and evaluated. The results are shown in Table 1.

### Example 7

In the same manner as in Example 1, except that the amount of the novolac resin in the heat sensitive layer composition solution was changed to 102 parts by weight, the amount of polyurethane was changed to 47 parts by weight, and the amount of tetrahydrofuran was changed to 627 parts by weight, a directly imageable waterless lithographic printing plate precursor was produced and evaluated. The results are shown in Table 1.

### Example 8

In the same manner as in Example 1, except that the amount of the novolac resin in the heat sensitive layer composition solution was changed to 105 parts by weight, the amount of polyurethane was changed to 37 parts by weight, and the amount of tetrahydrofuran was changed to 633 parts by weight, a directly imageable waterless lithographic printing plate precursor was produced and evaluated. The results are shown in Table 1,

### Example 9

In the same manner as in Example 1, except that the novolac resin in the heat sensitive layer composition solution was replaced by 88 parts by weight of “Sumilite Resin” (registered trademark) PR50731 (manufactured by Sumitomo Bakelite Co., Ltd., weight average molecular weight: about 8,000); polyurethane was replaced by 93 parts by weight of “Sanprene” (registered trademark) LQ-336N (manufactured by Sanyo Chemical Industries Ltd., polyurethane obtained from polyisocyanate in which aromatic polyisocyanate accounts for 50 mol % or more thereof, and polyester polyol, softening point: 215° C., solid component concentration: 30% by weight); and isoparaffin was replaced by 26 parts by weight of “Isopar” (registered trademark) H (manufactured by Esso Chemical Co., Ltd., boiling point: 178 to 188° C., solubility parameter: 14.7 (MPa)^{1/2}); and the amount of tetrahydrofuran was changed to 585 parts by weight, a directly imageable waterless lithographic printing plate was produced. A photomicrograph of a surface of the heat sensitive layer obtained in Example 9 is shown in FIG. 6. The scale in the drawing shows a length of 10 μm. The drawing shows a phase separation structure in which a phase containing relatively large amount of polyurethane is distributed in the form of a network in a matrix phase containing relatively small amount of polyurethane.

With regard to the obtained directly imageable waterless lithographic printing plate, TEM observation was performed by the above procedure. As a result, bubbles were observation in the heat sensitive layer. The bubbles had a diameter of 0.1 to 0.7 μm. In the same manner as in Example 1, observation of the phase separation structure as well as evaluation of blister resistance and solid reproducibility were performed. The results are shown in Table 1.

### Example 10

In the same manner as in Example 9, except that the amount of the novolac resin in the heat sensitive layer composition solution was changed to 94 parts by weight, the amount of polyurethane to 75 parts by weight, and the amount of tetrahydrofuran was changed to 598 parts by weight, a directly imageable waterless lithographic printing plate precursor was produced and evaluated. The results are shown in Table 1.

### Example 11

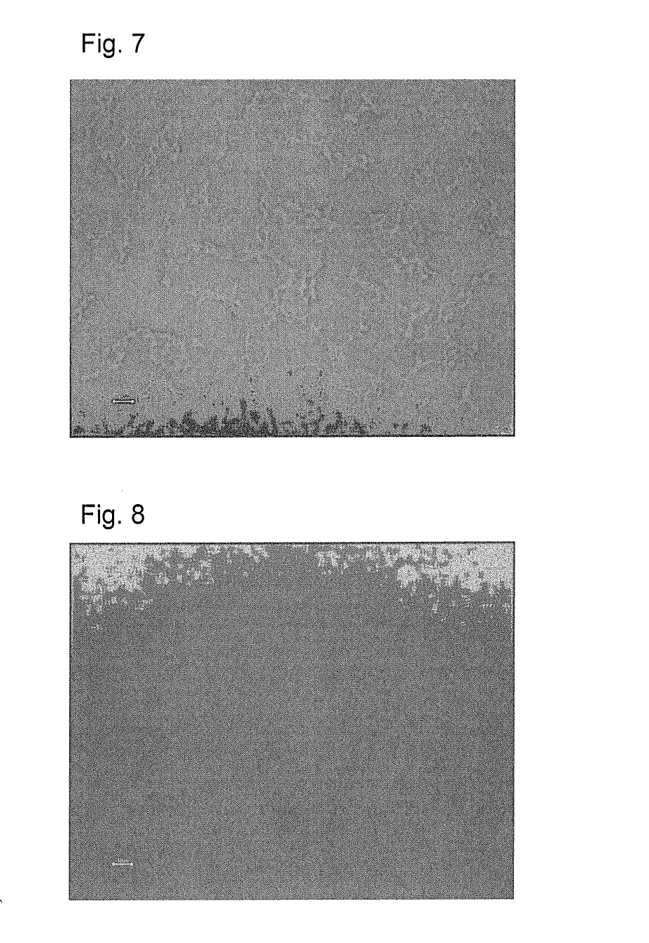

In the same manner as in Example 9, except that the amount of the novolac resin in the heat sensitive layer composition solution was changed to 99 parts by weight, the amount of polyurethane to 56 parts by weight, and the amount of tetrahydrofuran was changed to 612 parts by weight, a directly imageable waterless lithographic printing plate precursor was produced and evaluated. The results are shown in Table 1. A photomicrograph of a surface of the heat sensitive layer obtained in Example 11 is shown in FIG. 7. The scale in the drawing shows a length of 10 p.m. The drawing shows a phase separation structure in which a phase containing relatively large amount of polyurethane is distributed in the form of a network in a matrix phase containing relatively small amount of polyurethane.

### Example 12

In the same manner as in Example 9, except that the amount of the novolac resin in the heat sensitive layer composition solution was changed to 105 parts by weight, the amount of polyurethane was changed to 37 parts by weight, and the amount of tetrahydrofuran was changed to 625 parts by weight, a directly imageable waterless lithographic printing plate precursor was produced and evaluated. The results are shown in Table 1.

### Examples 13 to 16

In the same manner as in Examples 9 to 12, except that the novolac resin in the heat sensitive layer composition solution was replaced by “Sumilite Resin” (registered trademark) PR50716 (manufactured by Sumitomo Bakelite Co., Ltd., weight average molecular weight: about 3,500), directly imageable waterless lithographic printing plate precursors were produced and evaluated. The results are shown in Table 1.

### Example 17

In the same manner as in Example 9, except that isoparaffin in the heat sensitive layer composition solution was replaced by 17 parts by weight of “Isopar” M (manufactured by Esso Chemical Co., Ltd., boiling point: 223 to 254° C., solubility parameter: 14.7 (MPa)^{1/2}), and the amount of tetrahydrofuran was changed to 594 parts by weight, a directly imageable waterless lithographic printing plate precursor was produced and evaluated. The results are shown in Table 2.

### Example 18

In the same manner as in Example 1, except that polyurethane in the heat sensitive layer composition solution was replaced by 48 parts by weight of “Sanprene” (registered trademark) LQ-258 (manufactured by Sanyo Chemical Industries Ltd., polyurethane obtained from polyisocyanate in which aromatic polyisocyanate accounts for 50 mol % or more thereof, and a mixture of polyester polyol and polyether polyol, softening point: 205° C., solid component concentration: 35% by weight), and the amount of tetrahydrofuran was changed to 628 parts by weight, a directly imageable waterless lithographic printing plate precursor was produced and evaluated. The results are shown in Table 2.

### Example 19

In the same manner as in Example 1, except that polyurethane in the heat sensitive layer composition solution was replaced by “Sanprene” (registered trademark) LQ-2700 (manufactured by Sanyo Chemical Industries Ltd., polyurethane obtained from polyisocyanate in which aromatic polyisocyanate accounts for 50 mol % or more thereof, and polyether polyol, softening point: 200° C., solid component concentration: 30% by weight), a directly imageable waterless lithographic printing plate precursor was produced and evaluated. The results are shown in Table 2.

### Example 20

In the same manner as in Example 1, except that polyurethane in the heat sensitive layer composition solution was replaced by “Sanprene” (registered trademark) LQ-2300 (manufactured by Sanyo Chemical Industries Ltd., polyurethane obtained from polyisocyanate in which aromatic polyisocyanate accounts for 50 mol % or more thereof, and polyether polyol, softening point: 210° C., solid component concentration: 30% by weight), a directly imageable waterless lithographic printing plate precursor was produced and evaluated. The results are shown in Table 2.

### Comparative Example 1

In the same manner as in Example 9, except that polyurethane in the heat sensitive layer composition solution was replaced by 140 parts by weight of “Sanprene” LQ-T1331D (manufactured by Sanyo Chemical Industries Ltd., polyurethane obtained from polyisocyanate in which aromatic polyisocyanate accounts for less than 50 mol % thereof, and polyester polyol, softening point: 171° C., concentration: 20% by weight), and the amount of tetrahydrofuran was changed to 539 parts by weight, a directly imageable waterless lithographic printing plate precursor was produced and evaluated. The results are shown in Table 2.

### Comparative Example 2

In the same manner as in Example 17, except that polyurethane in the heat sensitive layer composition solution was replaced by “Sanprene” (registered trademark) IB-114B (manufactured by Sanyo Chemical Industries Ltd., polyurethane obtained from polyisocyanate in which aromatic polyisocyanate accounts for less than 50 mol % thereof, and polyester polyol, softening point: 110° C., solid component concentration: 30% by weight), a directly imageable waterless lithographic printing plate precursor was produced and evaluated. The results are shown in Table 2.

### Comparative Example 3

In the same manner as in Example 17, except that polyurethane in the heat sensitive layer composition solution was replaced by “Sanprene” (registered trademark) IB-104 (manufactured by Sanyo Chemical Industries Ltd., polyurethane obtained from polyisocyanate in which aromatic polyisocyanate accounts for less than 50 mol % thereof, and polyester polyol, softening point: 110° C., solid component concentration: 30% by weight), a directly imageable waterless lithographic printing plate precursor was produced and evaluated. The results are shown in Table 2.

### Comparative Example 4

In the same manner as in Example 17, except that polyurethane in the heat sensitive layer composition solution was replaced by “Sanprene” (registered trademark) IB-465 (manufactured by Sanyo Chemical Industries Ltd., polyurethane obtained from polyisocyanate in which aromatic polyisocyanate accounts for less than 50 mol % thereof, and polyester polyol, softening point: 120° C., solid component concentration: 30% by weight), a directly imageable waterless lithographic printing plate precursor was produced and evaluated. The results are shown in Table 2.

### Comparative Example 5

In the same manner as in Example 9, except that polyurethane in the heat sensitive layer composition solution was replaced by “Nippolan” (registered trademark) 5196 (manufactured by Nippon Polyurethane Industry Co., Ltd., polyurethane obtained from polyisocyanate in which aromatic polyisocyanate accounts for less than 50 mol % thereof, and polycarbonate polyol, softening point: 90° C., solid component concentration: 30% by weight), a directly imageable waterless lithographic printing plate precursor was produced and evaluated. The results are shown in Table 2.

### Comparative Example 6

In the same manner as in Comparative Example 5, except that the amount of the novolac resin in the heat sensitive layer composition solution was changed to 105 parts by weight, the amount of polyurethane was changed to 37 parts by weight, and the amount of tetrahydrofuran was changed to 625 parts by weight, a directly imageable waterless lithographic printing plate precursor was produced and evaluated. The results are shown in Table 2. A photomicrograph of a surface of the heat sensitive layer obtained in Comparative Example 6 is shown in FIG. 8. The scale in the drawing shows a length of 10 μm. Phase separation could not be recognized.

### Comparative Example 7

In the same manner as in Comparative Example 1, except that the novolac resin in the heat sensitive layer composition solution was replaced by “Sumilite Resin” (registered trademark) PR50716 (manufactured by Sumitomo Bakelite Co., Ltd., weight average molecular weight: about 3,500); isoparaffin was replaced by 17 parts by weight of “Isopar” M (manufactured by Esso Chemical Co., Ltd., boiling point: 223 to 254° C., solubility parameter: 14.7 (MPa)^{1/2}); and the amount of tetrahydrofuran was replaced by 547 parts by weight, a directly imageable waterless lithographic printing plate precursor was produced and evaluated. The results are shown in Table 2.

### Comparative Example 8

In the same manner as in Example 8, except that polyurethane in the heat sensitive layer composition solution was replaced by “Nippolan” (registered trademark) 5196 (manufactured by Nippon Polyurethane Industry Co., Ltd., polyurethane obtained from polyisocyanate in which aromatic polyisocyanate accounts for less than 50 mol % thereof, and polycarbonate polyol, softening point: 90° C., solid component concentration: 30% by weight), a directly imageable waterless lithographic printing plate precursor was produced and evaluated. The results are shown in Table 2.

### Comparative Example 9

In the same manner as in Comparative Example 6, except that polyurethane in the heat sensitive layer composition solution was replaced by 19 parts by weight of “Sanprene”LQ336N and 19 parts by weight “Nippolan” (registered trademark) 5196, a directly imageable waterless lithographic printing plate precursor was produced and evaluated. The results are shown in Table 2.

### Comparative Example 10

In the same manner as in Example 1, except that a heat sensitive layer was formed using a heat sensitive layer composition solution having the following composition in the same manner as in Example 3 of Japanese Unexamined Patent Publication (Kokai) No. 2000-238448, a directly imageable waterless lithographic printing plate precursor was produced and evaluated. The results are shown in Table 2.

(a) Infrared ray absorption dye: “KAYASORB”IR-820B (manufactured by Nippon Kayaku Co., Ltd.): 10 parts by weight
(b) Silane coupling agent: “TSL”8370 (manufactured by Toshiba Silicone Co., Ltd.): 14 parts by weight
(c) Titanium di-n-butoxybis(acetyl acetonate) solution: “Nācem” (registered trademark) titanium (manufactured by Nihon Kagaku Sangyo Co., Ltd., solid component concentration: 73% by weight): 9 parts by weight
(d) phenol-formaldehyde novolac resin: “Sumilite Resin” PR-50731 (manufactured by Sumitomo Durez Co., Ltd.): 33 parts by weight
(e) “Epoxyester” 3000M (manufactured by Kyoeisha Chemical Co., Ltd.): 25 parts by weight
(f) Polyurethane solution: “Sanprene” (registered trademark) LQ-909L (manufactured by Sanyo Chemical Industries Ltd., polyurethane obtained from polyisocyanate in which aromatic polyisocyanate accounts for 50 mol % or more thereof, and polyester polyol, softening point: 160° C., solid component concentration: 30% by weight): 19 parts by weight
(g) Tetrahydrofuran: 650 parts by weight
(h) Dimethylformamide: 200 parts by weight
(i) Acetyl acetone: 150 parts by weight

TABLE 1

| | Novolac resin | | Polyurethane | | |
|---|---|---|---|---|---|
| | | Additive amount | | Proportion of | Additive amount |
| | | (Content in solid | | aromatic | (Content in solid |
| | | component of heat | | polyisocyanate in | component of heat |
| | Name | sensitive layer) | Name | polyisocyanate | sensitive layer) |
| Example 1 | PR50716 | 99 Parts by weight | LQ-X5 | 50 mol % or more | 56 Parts by weight |
| Example 2 | | (71% by weight) | Polyurethane A of | 100 mol % | (12% by weight) |
| | | | Synthetic Example 1 | | |
| Example 3 | | | LQ-X5 | 50 mol % or more | |
| Example 4 | | | | | |
| Example 5 | | 94 Parts by weight | | | 75 Parts by weight |
| | | (67% by weight) | | | (16% by weight) |
| Example 6 | | 97 Parts by weight | | | 65 Parts by weight |
| | | (69% by weight) | | | (14% by weight) |
| Example 7 | | 102 Parts by weight | | | 47 Parts by weight |
| | | (73% by weight) | | | (10% by weight) |
| Example 8 | | 105 Parts by weight | | | 37 Parts by weight |
| | | (75% by weight) | | | (8% by weight) |
| Example 9 | PR50731 | 88 Parts by weight | LQ-336N | | 93 Parts by weight |
| | | (63% by weight) | | | (20% by weight) |
| Example 10 | | 94 Parts by weight | | | 75 Parts by weight |
| | | (67% by weight) | | | (16% by weight) |
| Example 11 | | 99 Parts by weight | | | 56 Parts by weight |
| | | (71% by weight) | | | (12% by weight) |
| Example 12 | | 105 Parts by weight | | | 37 Parts by weight |
| | | (75% by weight) | | | (8% by weight) |
| Example 13 | PR50716 | 88 Parts by weight | | | 93 Parts by weight |
| | | (63% by weight) | | | (20% by weight) |
| Example 14 | | 94 Parts by weight | | | 75 Parts by weight |
| | | (67% by weight) | | | (16% by weight) |
| Example 15 | | 99 Parts by weight | | | 56 Parts by weight |
| | | (71% by weight) | | | (12% by weight) |
| Example 16 | | 105 Parts by weight | | | 37 Parts by weight |
| | | (75% by weight) | | | (8% by weight) |

| | Solid component | Presence or | | | |
|---|---|---|---|---|---|
| | concentration of | absence of | | | |
| | heat sensitive | phase | Solid | Blister | |
| | layer composition | separation | reproducibility | resistance | Latitude |
| | liquid (wt %) | structure | (mJ/cm²) | (mJ/cm²) | (mJ/cm²) |
| Example 1 | 14 | Observed | 85 | 175 | 90 |
| Example 2 | | Observed | 85 | 175 | 90 |
| Example 3 | 18 | Observed | 80 | 140 | 60 |
| Example 4 | 10 | Observed | 90 | 175 | 85 |
| Example 5 | 14 | Observed | 90 | 175 | 85 |
| Example 6 | | Observed | 90 | 175 | 85 |
| Example 7 | | Observed | 85 | 150 | 65 |
| Example 8 | | Observed | 80 | 115 | 35 |
| Example 9 | | Observed | 125 | 175 | 50 |
| Example 10 | | Observed | 115 | 175 | 60 |
| Example 11 | | Observed | 110 | 175 | 65 |
| Example 12 | | Observed | 100 | 130 | 30 |
| Example 13 | | Observed | 110 | 175 | 65 |
| Example 14 | | Observed | 95 | 175 | 80 |
| Example 15 | | Observed | 95 | 175 | 80 |
| Example 16 | | Observed | 90 | 125 | 35 |

TABLE 2

| | Novolac resin | | Polyurethane | | |
|---|---|---|---|---|---|
| | | Additive amount | | Proportion of | Additive amount |
| | | (Content in solid | | aromatic | (Content in solid |
| | | component of heat | | polyisocyanate in | component of heat |
| | Name | sensitive layer) | Name | polyisocyanate | sensitive layer) |
| Example 17 | PR50731 | 88 Parts by weight | LQ-336N | 50 mol % or more | 93 Parts by weight |
| | | (63% by weight) | | | (20% by weight) |
| Example 18 | PR50716 | 99 Parts by weight | LQ-258 | | 48 Parts by weight |
| | | (71% by weight) | | | (12% by weight) |
| Example 19 | | | LQ-2700 | | 56 Parts by weight |
| Example 20 | | | LQ-2300 | | (12% by weight) |
| Comparative | PR50731 | 88 Parts by weight | LQ-T1331D | Less than 50 mol % | 140 Parts by weight |
| Example 1 | | (63% by weight) | | | (20% by weight) |
| Comparative | | | IB-114B | | 93 Parts by weight |
| Example 2 | | | | | (20% by weight) |
| Comparative | | | IB-104 | | |
| Example 3 | | | | | |
| Comparative | | | IB-465 | | |
| Example 4 | | | | | |
| Comparative | | | Nippolan 5196 | | |
| Example 5 | | | | | |
| Comparative | | 105 Parts by weight | | | 37 Parts by weight |
| Example 6 | | (75% by weight) | | | (8% by weight) |
| Comparative | PR50716 | 88 Parts by weight | LQ-T1331D | | 140 Parts by weight |
| Example 7 | | (63% by weight) | | | (20% by weight) |
| Comparative | | 105 Parts by weight | Nippolan 5196 | | 37 Parts by weight |
| Example 8 | | (75% by weight) | | | (8% by weight) |
| Comparative | PR50731 | 105 Parts by weight | Nippolan 5196 + | Less than 50 mol % | 38 Parts by weight |
| Example 9 | | (75% by weight) | LQ-336N | | (8% by weight) |
| Comparative | PR50731 | 33 Parts by weight | LQ-909L | | 19 Parts by weight |
| Example 10 | | (35% by weight) | | | (6% by weight) |

| | Solid component | Presence or | | | |
|---|---|---|---|---|---|
| | concentration of | absence of | | | |
| | heat sensitive | phase | Solid | Blister | |
| | layer composition | separation | reproducibility | resistance | Latitude |
| | liquid (wt %) | structure | (mJ/cm²) | (mJ/cm²) | (mJ/cm²) |
| Example 17 | 14 | Observed | 110 | 175 | 65 |
| Example 18 | | Observed | 95 | 175 | 80 |
| Example 19 | | Observed | 90 | 175 | 85 |
| Example 20 | | Observed | 95 | 175 | 80 |
| Comparative | 14 | Not observed | 165 | 165 | 0 |
| Example 1 | | | | | |
| Comparative | | Not observed | 150 | 150 | 0 |
| Example 2 | | | | | |
| Comparative | | Not observed | 150 | 150 | 0 |
| Example 3 | | | | | |
| Comparative | | Not observed | 140 | 140 | 0 |
| Example 4 | | | | | |
| Comparative | | Not observed | 140 | 140 | 0 |
| Example 5 | | | | | |
| Comparative | | Not observed | 100 | 100 | 0 |
| Example 6 | | | | | |
| Comparative | | Not observed | 155 | 155 | 0 |
| Example 7 | | | | | |
| Comparative | | Not observed | 90 | 90 | 0 |
| Example 8 | | | | | |
| Comparative | | Not observed | 95 | 105 | 10 |
| Example 9 | | | | | |
| Comparative | 8.5 | Not observed | 175 | 175 | 0 |
| Example 10 | | | | | |

### INDUSTRIAL APPLICABILITY

It is possible to obtain a directly imageable waterless lithographic printing plate precursor having wide latitude, which has high sensitivity and is excellent in blister resistance.

1. A directly imageable waterless lithographic printing plate precursor comprising at least a heat sensitive layer and a silicone rubber layer formed on a substrate in this order, wherein the heat sensitive layer contains at least a novolac resin, a polyurethane and a light-to-heat conversion material, and has a phase separation structure including at least a phase containing a novolac resin and a phase containing a polyurethane.

2. The precursor according to claim 1, wherein the heat sensitive layer further contains an organic complex compound.

3. The precursor according to claim 1, wherein the polyurethane is a polyurethane obtained from a polyisocyanate and a polyhydric alcohol, and an aromatic polyisocyanate accounts for at least 50 mol % of the polyisocyanate.

4. The precursor according to claim 1, wherein the novolac resin has a weight average molecular weight of 5,000 or less.

5. The precursor according to claim 2, wherein the polyurethane is a polyurethane obtained from a polyisocyanate and a polyhydric alcohol, and an aromatic polyisocyanate accounts for at least 50 mol % of the polyisocyanate.

6. The precursor according to claim 2, wherein the novolac resin has a weight average molecular weight of 5,000 or less.

7. The precursor according to claim 3, wherein the novolac resin has a weight average molecular weight of 5,000 or less.
